(19) United States
(12) Patent Application Publication
(10) Pub. No.: US 2010/0301666 A1
(43) Pub. Date: Dec. 2, 2010

(54) BEARING DEVICE FOR WHEEL

(75) Inventors: Kiyotake Shibata, Shizuoka (JP); Kiyoshige Yamauchi, Shizuoka (JP)

Correspondence Address: STAAS & HALSEY LLP, SUITE 700, 1201 NEW YORK AVENUE, N.W., WASHINGTON, DC, 20005, US

(73) Assignee: NTN CORPORATION, OSAKA (JP)

(21) Appl. No.: 12/735,493

(22) PCT Filed: Jan. 20, 2009
(86) PCT No.: PCT/JP2009/000171

§ 371 Date: Jul. 21, 2010

(30) Foreign Application Priority Data
Jan. 23, 2008 (JP) 2008-012153

(51) Int. Cl. B60B 27/02; F16C 19/18

(52) U.S. Cl. 301/109

(57) ABSTRACT

A wheel support bearing assembly, in which rust preventive treatment is conducted to a pilot portion of a hub axle thereof to thereby increase the productivity and the reliability, is provided. This wheel support bearing assembly includes an outer member having rolling surfaces, an inner member having rolling surfaces opposed to the rolling surfaces of the outer member, and rows of rolling elements interposed between those opposed rolling surfaces. One of the outer and inner members that serves as a rotating member includes a hub axle having a wheel mounting hub flange and a cylindrical pilot portion protruding on an outboard side from a root portion of the hub flange for guiding a brake rotor and a wheel, both fitted to the hub flange. A coating layer of ultraviolet curable coating material is formed on a peripheral surface of the pilot portion.

### CROSS REFERENCE TO THE RELATED APPLICATION

This application is based on and claims priority to Japanese patent application No. 2008-012153, filed Jan. 23, 2008, the entire disclosure of which is herein incorporated by reference as a part of this application.

### BACKGROUND OF THE INVENTION

1. Field of the Invention

The present invention relates to a wheel support bearing assembly for use in automotive vehicles and freight train cars.

2. Description of the Related Art

In the wheel support bearing assembly generally used, the pilot portion of the hub axle is formed with a paint film for rust preventive purpose. To form this paint film, a brush painting, a spray painting or an electrodeposition coating is generally employed, which is followed by baking to finish the coating material film. (See, for example, the Patent Document 1 listed below.)

[Patent Document 1] JP Laid-open Patent Publication No. 2007-223600

### SUMMARY OF THE INVENTION

It has, however, been found that with the related art brush painting or the spray painting, several days, say, four to five days are required before the coating material film is completely cured and, during the production process before the coating material film is completely cured, problems such as, for example, exfoliation of and/or damages to the coating material film during the handling of the product tend to occur. Also, in the case of the coating material film formed by the utilization of the electrodeposition coating technique, a preparatory treatment prior to the electrodeposition, a baking subsequent to the electrodeposition and drying are required and the coating material film forming process requires a substantial number of process steps.

In view of the foregoing, an object of the present invention is to provide a wheel support bearing assembly, in which regarding the rust preventive treatment of the pilot portion of the hub axle thereof, the productivity and the reliability can be increased.

In order to accomplish the foregoing object, the wheel support bearing assembly according to one embodiment of the present invention is a wheel support bearing assembly for rotatably supporting a vehicle wheel relative to a vehicle body structure, which assembly includes an outer member having an inner periphery thereof formed with a plurality of rolling surfaces, an inner member having an outer periphery formed with rolling surfaces opposed to the rolling surfaces of the outer member, respectively, and a plurality of rows of rolling elements interposed between those opposed rolling surfaces, in which one of the outer and inner members that serves as a rotating member, includes a hub axle, having a wheel mounting hub flange and a cylindrical pilot portion protruding on an outboard side from a root portion of the hub flange for guiding a brake rotor and a wheel, both fitted to the hub flange, and a coating layer of an ultraviolet curable coating material formed on a peripheral surface of the pilot portion.

According to the above construction, since the coating layer of the ultraviolet curable coating material is formed on the peripheral surface of the pilot portion, this coating layer provides a rust preventive layer and, therefore, an effect of preventing the pilot portion from rusting can be obtained. Since the formation of the coating layer of the ultraviolet curable coating material completes with irradiation of the ultraviolet curable coating material with the ultraviolet rays, increase in temperature of the product is prevented, which would otherwise occur in baked painting. As a result, no thermal influence is brought on the product and, since curing takes place within a fraction of a second, the problem associated with peeling during the production process can also be removed. Since this kind of the ultraviolet curable coating material does not cure unless it is irradiated with ultraviolet rays, any error in coating can be remedied or repaired before it is not yet irradiated with ultraviolet rays. Also, since the coating material does not evaporate during storage thereof, a work to form the coating layer referred to above can easily be carried out. In view of those features, formation of the coating layer on the pilot portion peripheral surface can be formed in the matter of minutes and with a simplified process as compared with the conventional painting and the peripheral surface of the pilot portion can be covered with the coating layer which serves as a rust preventive layer. As a result thereof, with respect to the rust preventive treatment of the hub axle pilot portion, the productivity and the reliability can be increased.

In one embodiment of the present invention, the coating layer of the ultraviolet curable coating material on the hub axle may be formed on at least a wheel mounting area in an outer peripheral surface of the pilot portion. The wheel mounting area of the pilot portion is a site, where when rusting occurs removal or mounting of the vehicle wheel will be hampered, it is preferred to prevent any rusting with the highly reliable coating layer such as hereinabove described.

In one embodiment of the present invention, the coating layer of the ultraviolet curable coating material on the hub axle may be formed on at least an inner peripheral surface of the pilot portion. The inner peripheral surface of the pilot portion is a site where rusting is easy to occur and, once the rusting occurs, nut bearing surfaces for connection purpose, for example, in a type, in which a constant velocity joint is coupled, will be adversely affected. For this reason, a highly reliable rust preventive treatment brought about by the coating layer of the ultraviolet curable coating material will become effective.

In one embodiment of the present invention, the coating layer of the ultraviolet curable coating material on the hub axle may be formed on an inner peripheral surface and an end face of the pilot portion and a wheel mounting area in an outer peripheral surface of the pilot portion. Application of the coating layer of the ultraviolet curable coating material to this specific region is effective to provide a further excellent rust preventive property.

In one embodiment of the present invention, the coating layer of the ultraviolet curable coating material on the hub axle may be formed on an inner peripheral surface and an end face of the pilot portion, a wheel mounting area in an outer peripheral surface of the pilot portion and a brake rotor mounting area in the outer peripheral surface of the pilot portion. Although the brake rotor mounting area does not necessarily require the rust preventive treatment when compared with the wheel mounting area, formation of the coating layer so as to extend to the brake rotor mounting area as described above is effective to secure a further excellent rust preventive property.

In one embodiment of the present invention, the ultraviolet curable coating material may be an acrylic resin. The use of the acrylic resin can result in acceleration of the curing and also in an excellent productivity.

In one embodiment of the present invention, the ultraviolet curable coating material may be an ultraviolet curable coating material for use in vacuum deposition. Where the ultraviolet curable coating material is an ultraviolet curable coating material for use in vacuum deposition, the adherence of the coating layer can be increased with no need to add any adhesive agent to the ultraviolet curable coating material.

In one embodiment of the present invention, a dye and/or a pigment may be added to the ultraviolet curable coating material. It is, however, that the dye and/or the pigment when used must be of a kind capable of transmitting ultraviolet rays therethrough. When colored by the addition of the dye and/or the pigment, the presence or absence of the coating layer and deterioration thereof can be easily ascertained.

In one embodiment of the present invention, the wavelength of ultraviolet ray of light used to irradiate the ultraviolet curable coating material may be chosen to be within the range of 100 to 400 nm. The region within the range of 200 to 400 nm is more preferred. As a light source to be used for irradiation of the ultraviolet rays, any of a high pressure mercury lamp and a metal halide lamp is available and may be chosen in consideration of the coating material to be actually used.

In one embodiment of the present invention, the coating layer of the ultraviolet curable coating material may applied over an undercoating treatment layer of a primer for metal. When the coating layer of the ultraviolet curable coating material is applied over the undercoating treatment layer of the primer for metal as described above, the adherence of the coating layer to the peripheral surface of the pilot portion, which is made of a metallic material, can be increased.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a sectional view of a wheel support bearing assembly according to a first embodiment of the present invention;

FIG. 2A is a sectional view of a hub axle forming one of component parts of the wheel support bearing assembly;

FIG. 2B is a sectional view of a hub axle forming one of component parts of the wheel support bearing assembly;

FIG. 3 is an explanatory diagram showing the sequence of formation of a coating layer on a pilot portion of the hub axle;

FIG. 4 is a sectional view showing another example of formation of the coating layer on the pilot portion;

FIG. 5 is a sectional view showing a further example of formation of the coating layer on the pilot portion;

FIG. 6 is a sectional view showing a still further example of formation of the coating layer on the pilot portion;

FIG. 7 is a sectional view showing the wheel support bearing assembly according to a second embodiment of the present invention;

FIG. 8 is a sectional view showing the wheel support bearing assembly according to a third embodiment of the present invention;

FIG. 9 is a sectional view showing the wheel support bearing assembly according to a fourth embodiment of the present invention; and

FIG. 10 is a sectional view showing the wheel support bearing assembly according to a fifth embodiment of the present invention;

### DETAILED DESCRIPTION OF THE PREFERRED EMBODIMENTS

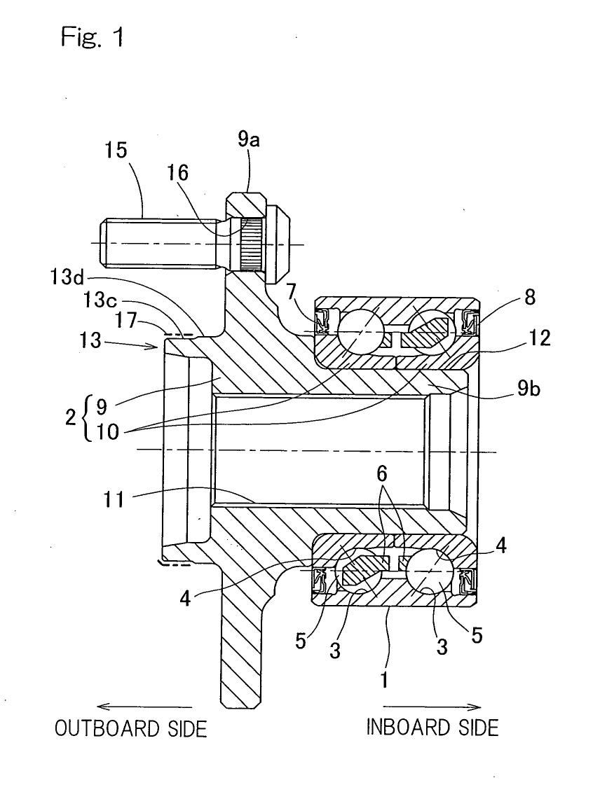

A first embodiment of the present invention will be described in detail with particular reference to FIGS. 1 to 3. The wheel support bearing assembly according to this embodiment is of a double row angular contact ball bearing model for use in an automotive vehicle, which is classified as a so-called first generation type, and is of an inner ring rotating type for use in supporting a vehicle drive wheel. It is to be noted that in the description that follows, one side of a vehicle body structure laterally away from the longitudinal center thereof in a condition, in which the bearing assembly is mounted on the vehicle body structure, is referred to as “outboard” whereas the opposite side of the vehicle body structure laterally close towards the longitudinal center thereof in the same condition is referred to as “inboard”.

This wheel support bearing assembly includes, as shown in a sectional view in FIG. 1, an outer member 1 having an inner periphery formed with a plurality of rolling surfaces 3, an inner member 2 having rolling surfaces 4 defined in face-to-face relation with the respective rolling surfaces 3, and a plurality of rows of rolling elements 5 interposed between the plurality of rows of those rolling surfaces 3 and 4. The rolling elements 5 are in the form of balls and are retained by a retainer 6 employed for each row. The rolling surfaces 3 and 4 referred to above have an arcuate shape in cross-section and are so formed as to represent respective contact angles that are held in back-to-back relation with each other. Opposite ends of a bearing space delimited between the outer and inner members 1 and 2 are sealed by respective sealing devices 7 and 8.

The outer member 1 serves as a stationary member and is a component part, which in its entirety forms an outer ring. The outer member 1 has an outer diametric surface, which in its entirety is rendered to be a cylindrical surface, and is secured to a cylindrical knuckle (not shown), forming a part of the automobile suspension system mounted on an automotive body structure, when it is mounted on an inner diametric surface of such cylindrical knuckle.

The inner member 2 serves as a rotating member and is made up of a hub axle 9 having an outer periphery formed with a wheel mounting hub flange 9a, and two inner rings 10 mounted on an outer periphery of an axle portion 9b of the hub axle 9 in juxtaposed relation with each other. The rolling surfaces 4 referred to above are formed on the inner rings 10, respectively. An inboard end portion of the hub axle 9 has an outer periphery provided with an inner ring mounting surface area 12 of a reduced diameter defined by radially inwardly stepping that inboard end portion, and the two inner rings 10 are mounted on this inner ring mounting surface area 12. The hub axle 9 has a center portion formed with a center through hole 11. A stem portion (not shown) of an outer ring of a constant velocity joint is inserted into this center through hole 11, and the wheel support bearing assembly and the constant velocity joint are coupled together with the inner member 2 clamped between a stepped face around a base end of the stem portion and a nut (not shown) threadingly engaged on a free end portion of the stem portion. The hub flange 9a is provided with press-fitting holes 16 defined at a plurality of locations circumferentially thereof for receiving corresponding hub bolts 15. At a portion of the hub axle 9 adjacent the root portion of the hub flange 9a, a cylindrical pilot portion 13 for guiding a brake rotor and a vehicle wheel (both not shown) protrudes towards the outboard side. An outer peripheral portion of the pilot portion 13 has an end portion remote from the hub flange 9a, which defines a wheel mounting area 13c, and also has a portion adjacent the root portion thereof, which defines a brake rotor mounting area 13d. The wheel mounting area 13c has a diameter somewhat smaller than that of the brake rotor mounting area 13d. By the guidance afforded by this pilot portion 13, the brake rotor and the vehicle wheel are overlapped with each other and are then fixed by the hub bolts 15 and corresponding nuts (not shown).

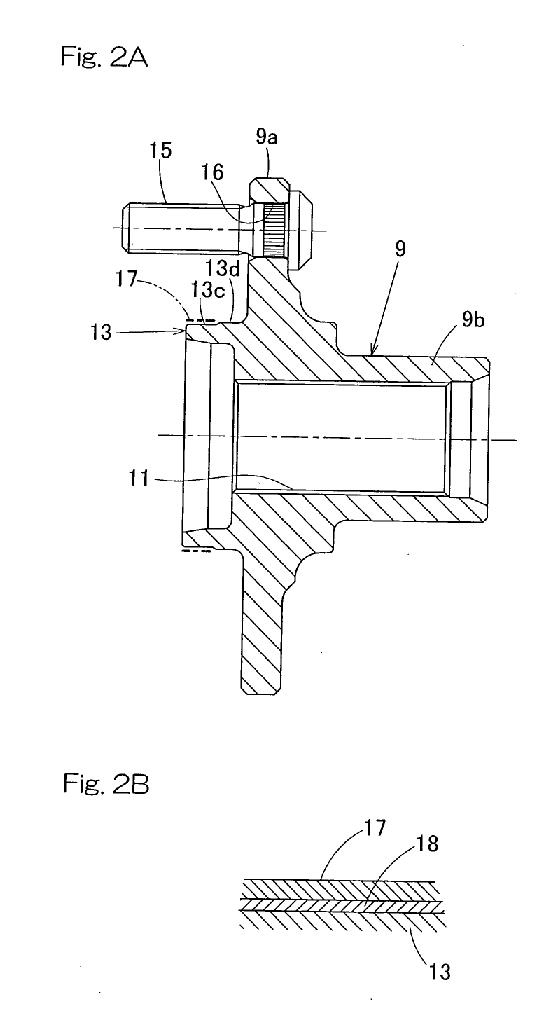

Referring to FIG. 2A showing a sectional view of the hub axle 9, the pilot portion 13 has an peripheral surface formed with a coating layer 17 of an ultraviolet curable coating material. More specifically, the coating layer 17 referred to above is formed on the mounting area 13c, which is one of halves of the pilot portion 13 that lies on the outboard side on the outer peripheral surface of the pilot portion 13 encompassing a surface region ranging from the root of the hub flange 9a.

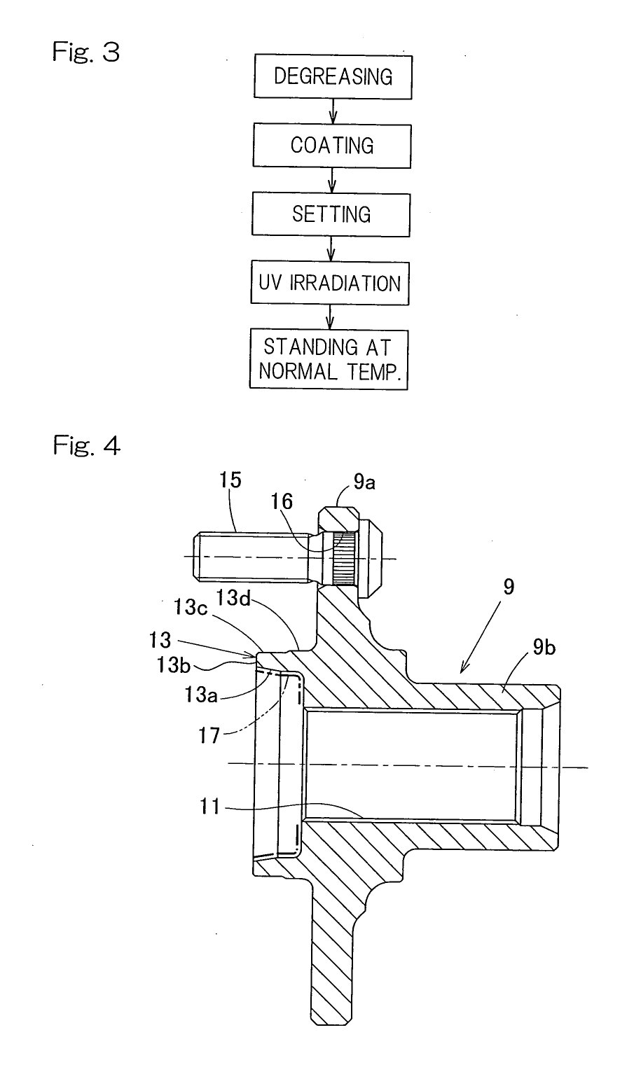

FIG. 3 illustrates a flowchart showing the sequence of formation of the coating layer of the ultraviolet curable coating material onto the outer peripheral surface of the pilot portion 13. This process is carried out in the sequence of degreasing→coating→setting→ultraviolet irradiation→standing at room temperature. More specifically, after a degreasing treatment has been applied to the outer peripheral surface of the pilot portion 13, the ultraviolet curable coating material is first coated by means of a dipping technique, a spraying technique or a brushing technique. Subsequently, organic components contained in the coating material are removed by setting. The setting is accomplished by allowing the applied ultraviolet curable coating material to stand, for example, for 3 to 5 minutes at 40° C. Thereafter, the coating material, which has been set, is irradiated with ultraviolet rays. This ultraviolet irradiation for, for example, about 10 seconds is satisfactory. Then, the coating material, which has been irradiated with ultraviolet rays, is allowed to stand at normal temperature. In this way, curing of the coating material completes when the temperature drops down to normal temperature, leaving the coating layer 17 of the ultraviolet curable coating material on the outer peripheral surface of the pilot portion 13.

The ultraviolet curable coating material of the kind referred to above is a resin paint material, which includes an oligomer of a kind having a polymeric double bond, a monomer, a photoinitiator, a dye and pigment, an anti-foam agent, additives such as, for example, a leveling agent and which when irradiated with ultraviolet rays, undergoes a photochemical reaction and is cured in seconds. Since this kind of the ultraviolet curable coating material does not cure unless it is irradiated with ultraviolet rays, any error in coating can be remedied or repaired before irradiation of the ultraviolet rays. Also, since the coating material does not evaporate during storage thereof, a work to form the coating layer 17 referred to above can easily be carried out. A light source used to emit rays necessary to cure the ultraviolet curable coating material is ultraviolet rays of a wavelength within the range of 100 to 400 nm (nanometer) and more preferably within the range of 200 to 400 nm and can be obtained from a high pressure mercury lamp or a metal halide lamp, the selection of one of which depends on the specific composition of the coating material used.

According to the wheel support bearing assembly of the construction described hereinabove, since the coating layer 17 of the ultraviolet curable coating material is formed on the peripheral surface of the pilot portion 13, the coating layer 17 serves as a rust preventive layer and, therefore, an rust preventive effect can be obtained on the pilot portion 13. Since the formation of the coating layer 17 of the ultraviolet curable coating material completes with irradiation of the ultraviolet curable coating material with the ultraviolet rays, increase in temperature of the product is prevented, which would otherwise result from baking or drying such as found in coating in the conventional example. As a result, thermal influence on the product is prevented and, since curing takes place within a fraction of a second, the problem associated with peeling during the production process can also be removed. In view of the above, according to this wheel support bearing assembly, the formation of the coating layer on the outer peripheral surface of the pilot portion 13 can be accomplished in a matter of minutes and with a simplified process and the outer peripheral surface of the pilot portion 13 can be covered with the coating layer 17 that serves as the rust preventive layer.

It is to be noted that although the ultraviolet curable coating material of the kind referred to above represents a substantially transparent color if not mixed with a dye or pigment, the coating layer 17 may be colored by mixing the ultraviolet curable coating material with a coloring dye or pigment, then painted and finally irradiated with ultraviolet rays. It is, however, to be noted that the dye or pigment and the color, which may be employed in this case, must be of a kind capable of transmitting ultraviolet rays therethrough.

Also, when the coating layer 17 of the kind referred to hereinbefore is to be formed on the peripheral surface of the pilot portion 13 made of a metallic material, the ultraviolet curable coating material may be employed in the form of an ultraviolet curable coating material for use in vacuum deposition. In such case, without any adhesive agent added to the ultraviolet curable coating material, the adherence of the coating layer 17 can be increased.

Furthermore, the coating layer 17 of the ultraviolet curable coating material employed in the foregoing embodiment may be coated on an undercoating treatment layer 18 of a metal primer as shown in an enlarged sectional view in FIG. 2B. The primer for the metal is an undercoating paint for increasing the adherence to a product material (material for the hub axle 9 in this case) and imparting an rust preventive capability thereto and, when the coating layer 17 is formed on this undercoating treatment layer 18 as suggested above, the adherence of the coating layer 17 to the outer peripheral surface of the pilot portion 13, which is a metal, can be increased.

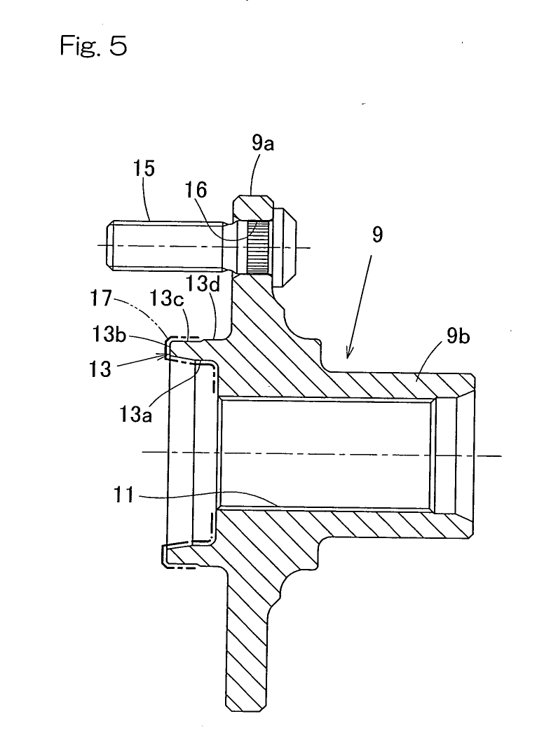

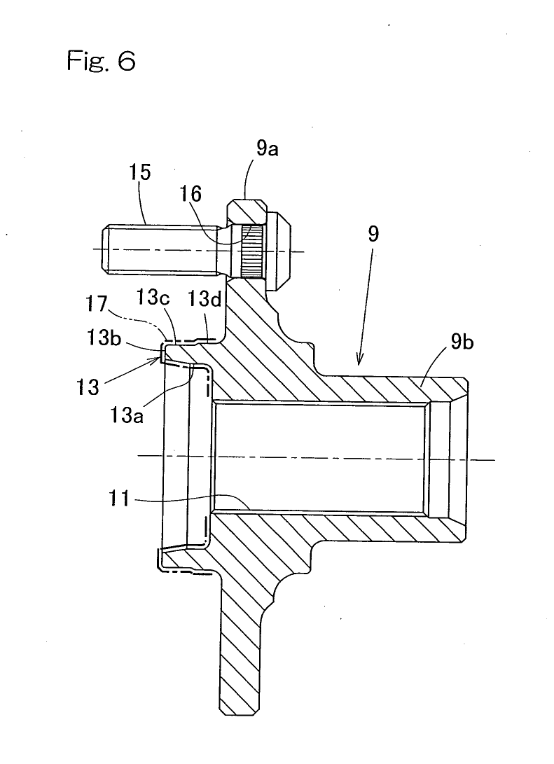

It is to be noted that although in FIG. 1 and FIGS. 2A and 2B, the coating layer 17 of the ultraviolet curable coating material has been shown and described as formed on the wheel mounting area 13c of the outer peripheral surface of the pilot portion 13, the coating layer 17 may be formed in a region shown in and described with particular reference to each of FIGS. 4 to 6. FIG. 4 illustrates an example, in which the coating layer 17 of the ultraviolet curable coating material is formed on an inner peripheral surface 13a of the pilot portion 13. FIG. 5 illustrates an example, in which the coating layer 17 of the ultraviolet curable coating material is formed on a surface region of the pilot portion 13 ranging from the inner peripheral surface 13a, an end face 13b and the wheel mounting area 13c of the outer peripheral surface of the pilot portion 13. FIG. 6 illustrates an example, in which the coating layer 17 of the ultraviolet curable coating material is formed on a surface region of the pilot portion 13 ranging from the inner peripheral surface 13a, the end face 13b, the wheel mounting area 13c and the brake rotor mounting area 13d.

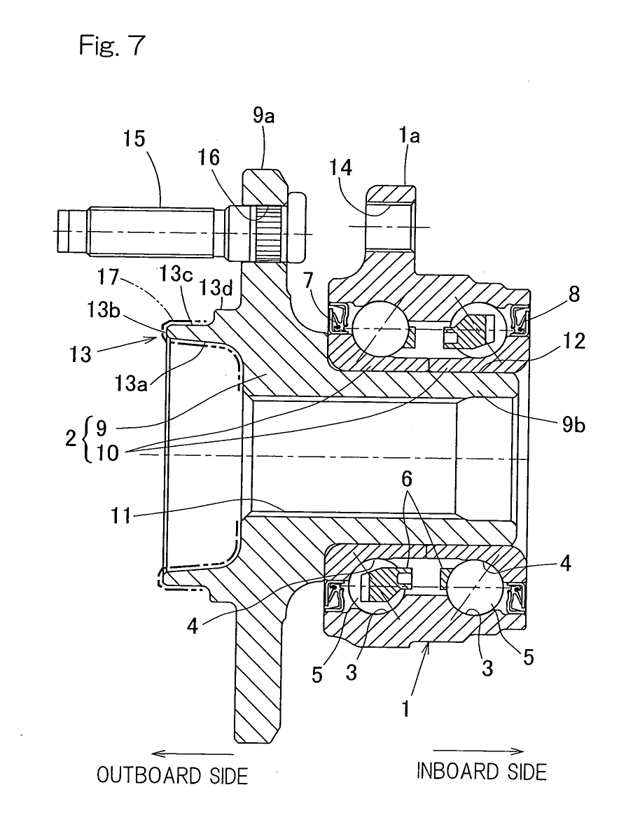

FIG. 7 illustrates a second embodiment of the present invention. The wheel support bearing assembly according to the embodiment shown therein is in the form of a double row angular contact bearing model, which is classified as a so-called second generation type, and is of an inner ring rotating type for use in supporting a vehicle drive wheel. The outer member 1 employed in such wheel support bearing assembly is of one piece construction including a vehicle body fitting flange 1a defined therein for connection with a knuckle (not shown) forming a part of the vehicle wheel suspension system mounted on the automotive body structure. This vehicle body fitting flange 1a has a vehicle body fitting bolt hole 14 defined therein at a plurality of locations circumferentially thereof and is bolted to the knuckle with corresponding knuckle bolts (not shown) inserted into bolt insertion holes (also not shown) in the knuckle from the inboard side and then firmly threaded into the respective holt holes 14. The coating layer 17 of the ultraviolet curable coating material, discussed in connection with the previous embodiment of the present invention, is formed continuously over the inner peripheral surface 13a of the pilot portion 13, the end face 13 thereof and the wheel mounting area 13c in the outer peripheral surface thereof. Other structural features are similar to those shown in and described with reference to FIGS. 1 to 3 in connection with the previously described first embodiment of the present invention.

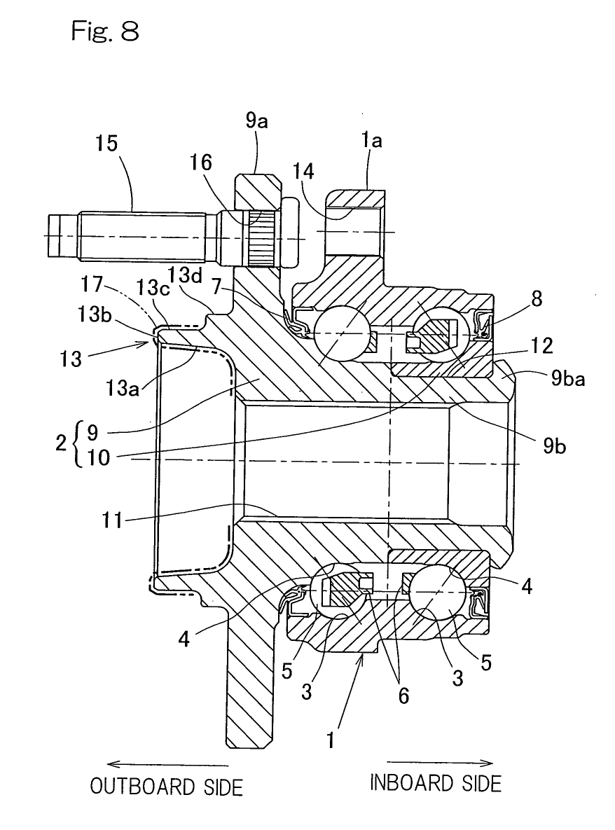

FIG. 8 illustrates a third embodiment of the present invention. The wheel support bearing assembly according to the embodiment shown therein is in the form of a double row angular contact ball bearing model, which is classified as a third generation type, and is of an inner ring rotating type for use in supporting a vehicle drive wheel. The inner member 2 employed in such wheel support bearing assembly is made up of a hub axle 9, having a wheel mounting hub flange 9a, and a single row of an inner ring 10 mounted on an inboard portion of an outer periphery of the axle portion 9b of the hub axle 9. The respective rolling surfaces 4 in the inner member 2 are formed respectively in the hub axle 9 and the inner ring 10. The hub axle 9 has an inboard end formed with a crimped portion 9ba, at which the inner ring 10 is crimped and fixed. Accordingly, the inner member 2 is clamped between a nut, threadingly mounted on a free end of the stem portion (not shown) of the outer ring of the wheel support bearing assembly and the crimped portion 9ba referred to above to thereby connect the wheel support bearing assembly and the constant velocity joint together. The design, in which the outer periphery of the outer member 1 is formed with the vehicle body fitting flange 1a for connection with the knuckle (not shown) of the automobile suspension system and the coating layer 17 of the ultraviolet curable coating material is formed over the inner peripheral surface 13a and the end face 13b of the pilot portion 13 and the wheel mounting area 13c of the outer peripheral surface of the pilot portion 13 is similar to that employed in the previously described second embodiment shown in FIG. 7. Other structural features are similar to those shown in and described with reference to FIGS. 1 to 3 in connection with the previously described first embodiment of the present invention.

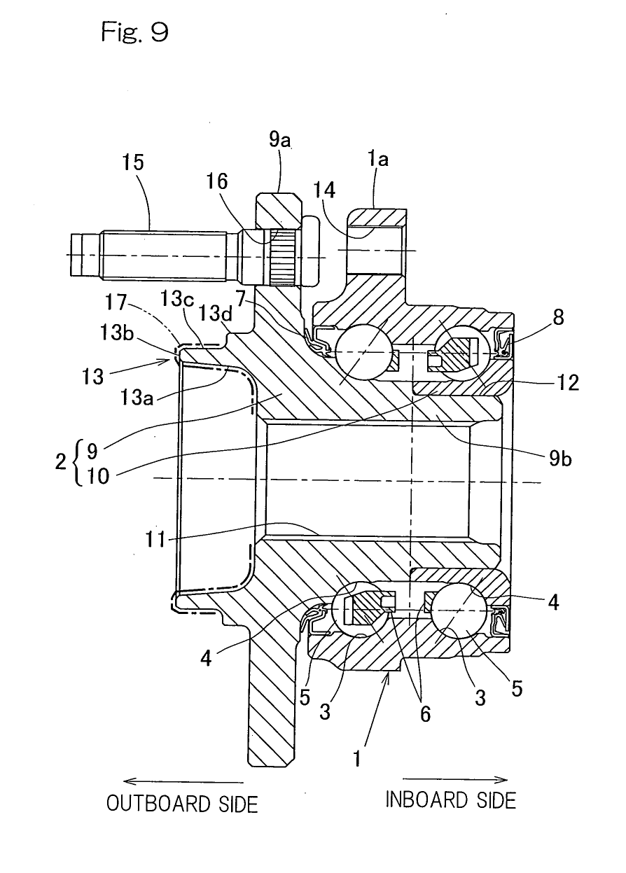

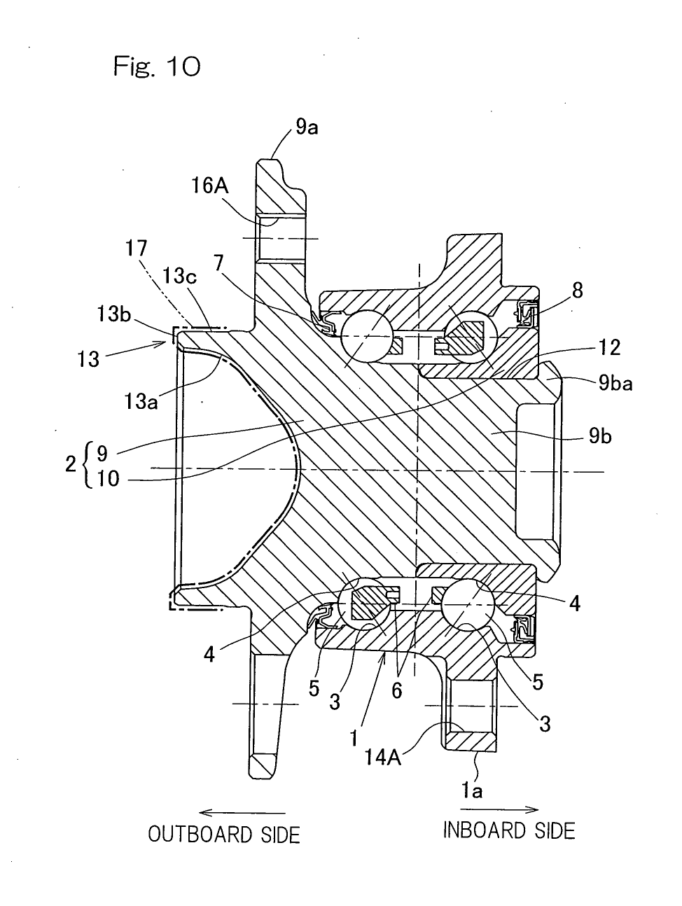

FIG. 9 illustrates a fourth embodiment of the present invention. This fourth embodiment is such that in the wheel support bearing assembly of the structure according to the third embodiment of the present invention, no crimped portion is formed in the inboard end of the axle portion 9b of the hub axle 9 and, instead, the inner member 2 is clamped between the stepped face (not shown) around the base end of the stem portion of the outer ring of the constant velocity joint and the nut (also not shown) threadingly engaged on the free end portion, to thereby connect the wheel support bearing assembly and the constant velocity joint together. Other structural features are similar to those shown in and described with reference to FIG. 8 in connection with the previously described third embodiment of the present invention.

FIG. 5 illustrates a fifth embodiment of the present invention. The wheel support bearing assembly according to the embodiment shown therein is in the form of a double row angular contact ball bearing model, which is classified as a third generation type, and is of an inner ring rotating type for use in supporting a vehicle driven wheel. The inner member 2, which serves as the rotating member, is made up of the hub axle 9, having the wheel mounting hub flange 9a, and the inner ring 10 mounted on the inboard portion of the outer periphery of the axle portion 9b of the hub axle 9, and the crimped portion 9ba is formed in the inboard end of the axle portion 9b of the hub axle 9 for crimping and fixing the inner ring 10. The hub axle 9 employed in this embodiment is in the form of a solid body and is not formed with the center through hole such as indicated by 11 in FIG. 8 and employed in the previously described third embodiment of the present invention and, therefore, the constant velocity joint is not connected with the wheel support bearing assembly. The bolt holes 14 shown as defined in the wheel mounting flange 1a in FIG. 8 are replaced with bolt insertion holes 14A and, also, the press fitting holes 16 shown as defined in the hub flange 9a in FIG. 8 are replaced with bolt holes 16A. Other structural features are similar to those shown in and described in connection with the previously described third embodiment with reference to FIG. 8.

It is to be noted that although in describing each of the foregoing embodiments of the present invention, reference has been made to the double row rolling bearing assembly employed in the form of the double row angular contact ball bearing assembly of a type utilizing the balls for the rolling elements, the present invention is not necessarily limited to that type and may be equally applied to, for example, a double row tapered roller bearing assembly of a type utilizing tapered rollers for the rolling elements.

Although the present invention has been fully described in connection with the embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. A wheel support bearing assembly for rotatably supporting a vehicle wheel relative to a vehicle body structure, comprising:
an outer member having an inner periphery thereof formed with a plurality of rolling surfaces;
an inner member having an outer periphery formed with rolling surfaces opposed to the rolling surfaces of the outer member; and
a plurality of rows of rolling elements interposed between those opposed rolling surfaces:
wherein one of the outer member and the inner member that serves as a rotating member includes a hub axle having a wheel mounting hub flange and a cylindrical pilot portion protruding on an outboard side from a root portion of the hub flange for guiding a brake rotor and a wheel, both fitted to the hub flange, and
wherein the pilot portion of the hub axle has a peripheral surface provided with a coating layer of an ultraviolet curable coating material.

2. The wheel support bearing assembly as claimed in claim 1, wherein the coating layer of the ultraviolet curable coating material on the hub axle is formed on at least a wheel mounting area in an outer peripheral surface of the pilot portion.

3. The wheel support bearing assembly as claimed in claim 1, wherein the coating layer of the ultraviolet curable coating material on the hub axle is formed on at least an inner peripheral surface of the pilot portion.

4. The wheel support bearing assembly as claimed in claim 1, wherein the coating layer of the ultraviolet curable coating material on the hub axle is formed over an inner peripheral surface of the pilot portion, an end face of the pilot portion and a wheel mounting area in an outer peripheral surface of the pilot portion.

5. The wheel support bearing assembly as claimed in claim 1, wherein the coating layer of the ultraviolet curable coating material on the hub axle is formed over an inner peripheral surface of the pilot portion, an end face of the pilot portion, a wheel mounting area in an outer peripheral surface of the pilot portion and a brake rotor mounting area in the outer peripheral surface of the pilot portion.

6. The wheel support bearing assembly as claimed in claim 1, wherein the ultraviolet curable coating material includes an acrylic resin.

7. The wheel support bearing assembly as claimed in claim 1, wherein the ultraviolet curable coating material is an ultraviolet curable coating material for use in vacuum deposition.

8. The wheel support bearing assembly as claimed in claim 1, wherein a dye and/or a pigment are added to the ultraviolet curable coating material.

9. The wheel support bearing assembly as claimed in claim 1, wherein the wavelength of ultraviolet ray of light used to irradiate the ultraviolet curable coating material is chosen to be within the range of 100 to 400 nm.

10. The wheel support bearing assembly as claimed in claim 1, wherein the coating layer of the ultraviolet curable coating material is applied over an undercoating treatment layer of a primer for metal.
